(19) United States
(12) Patent Application Publication
(10) Pub. No.: US 2007/0183494 A1
(43) Pub. Date: Aug. 9, 2007

(54) Buffering of decoded reference pictures

(75) Inventor: Miska Hannuksela, Ruutana (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/651,434

(22) Filed: Jan. 8, 2007

Related U.S. Application Data
(60) Provisional application No. 60/757,936, filed on Jan. 10, 2006.

(51) Int. Cl. H04B 1/66; H04N 11/02

(52) U.S. Cl. 375/240.1; 375/240.25

(57) ABSTRACT

A method of decoding a scalable video data stream comprising a base layer and at least one enhancement layer, the method comprising: decoding pictures of the video data stream according to a first decoding algorithm, if pictures only from the base layer are to be decoded; and decoding pictures of the video data stream according to a second decoding algorithm, if pictures from the base layer and from at least one enhancement layer are to be decoded.

### CROSS REFERENCE TO RELATED APPLICATIONS

This application claims priority under 35 USC §119 to U.S. Provisional Patent Application No. 60/757,936 filed on Jan. 10, 2006.

### FIELD OF THE INVENTION

The present invention relates to scalable video coding, and more particularly to buffering of decoded reference pictures.

### BACKGROUND OF THE INVENTION

Some video coding systems employ scalable coding in which some elements or element groups of a video sequence can be removed without affecting the reconstruction of other parts of the video sequence. Scalable video coding is a desirable feature for many multimedia applications and services used in systems employing decoders with a wide range of processing power. Scalable bit streams can be used, for example, for rate adaptation of pre-encoded unicast streams in a streaming server and for transmission of a single bit stream to terminals having different capabilities and/or with different network conditions.

Scalability is typically implemented by grouping the image frames into a number of hierarchical layers. The image frames coded into the image frames of the base layer substantially comprise only the ones that are compulsory for the decoding of the video information at the receiving end. One or more enhancement layers can be determined above the base layer, each one of the layers improving the quality of the decoded video in comparison with a lower layer. However, a meaningful decoded representation can be produced by decoding only certain parts of a scalable bit stream.

An enhancement layer may enhance the temporal resolution (i.e. the frame rate), the spatial resolution, or just the quality. In some cases, data of an enhancement layer can be truncated after a certain location, even at arbitrary positions, whereby each truncation position with some additional data represents increasingly enhanced visual quality. Such scalability is called fine-grained (granularity) scalability (FGS). In contrast to FGS, the scalability provided by a quality enhancement layer not providing fine-grained scalability is called coarse-grained scalability (CGS).

One of the current development projects in the field of scalable video coding is the Scalable Video Coding (SVC) standard, which will later become the scalable extension to ITU-T H.264 video coding standard (also know as ISO/IEC MPEG-4 AVC). According to the SVC standard draft, a coded picture in a spatial or CGS enhancement layer includes an indication of the inter-layer prediction basis. The inter-layer prediction includes prediction of one or more of the following three parameters: coding mode, motion information and sample residual. Use of inter-layer prediction can significantly improve the coding efficiency of enhancement layers. Inter-layer prediction always comes from lower layers, i.e. a higher layer is never required in decoding of a lower layer.

In a scalable video bitstream, for an enhancement layer picture a picture from whichever lower layer may be selected for inter-layer prediction. Accordingly, if the video stream includes multiple scalable layers, it may include pictures on intermediate layers, which are not needed in decoding and playback of an entire upper layer. Such pictures are referred to as non-required pictures (for decoding of the entire upper layer).

In the decoding process, the decoded pictures are placed in a picture buffer for a delay, which is required to recover the actual order of the picture frames. However, the prior-art scalable video methods have the serious disadvantage that hierarchical temporal scalability consumes unnecessarily many frame slots in the decoded picture buffer. When hierarchical temporal scalability is utilized in H.264/AVC and SVC by removing some of the temporal levels including reference pictures, the state of the decoded picture buffer is maintained essentially unchanged in both the original bitstream and the pruned bitstream with the decoding process, wherein frame numbering includes gaps. This is due to the fact that the decoding process generates “non-existing” frames marked as “used for short-term reference” for missing values of frame numbers that correspond to the removed reference pictures. The sliding window decoded reference picture marking process is used to mark reference pictures when the “non-existing” frames are generated. In this process, only pictures on the base layer are marked as “used for long-term reference” when they are decoded. All the other pictures may be subject to removal and must therefore be handled identically to the corresponding “non-existing” frames that are generated in the decoder as the response of the removal.

This has the impact that the number of buffered decoded pictures easily increases to a level, which significantly exceeds a typical size of decoded picture buffer in the levels specified in H.264/AVC (i.e. about 5). Since many of the reference pictures marked as “used for short-term reference” are actually not used for reference in subsequent pictures in the same temporal level, it would be desirable to handle the decoded picture marking process more efficiently.

### SUMMARY OF THE INVENTION

Now there is invented an improved method and technical equipment implementing the method, by which the number of buffered decoded pictures can be decreased. Various aspects of the invention include an encoding and a decoding method, an encoder, a decoder, a video encoding device, a video decoding device, computer programs for performing the encoding and the decoding, and a data structure, which aspects are characterized by what is stated below. Various embodiments of the invention are disclosed.

According to a first aspect, a method according to the invention is based on the idea of decoding a scalable video data stream comprising a base layer and at least one enhancement layer, the method comprising: decoding pictures of the video data stream according to a first decoding algorithm, if pictures only from the base layer are to be decoded; and decoding pictures of the video data stream according to a second decoding algorithm, if pictures from the base layer and from at least one enhancement layer are to be decoded.

According to an embodiment, the steps of decoding pictures of the video data stream include a process of marking decoded reference pictures.

According to an embodiment, said first decoding algorithm is compliant with a sliding window decoded reference picture marking process according to H.264/AVC.

According to an embodiment, said second decoding algorithm carries out a sliding window decoded reference picture marking process, which is operated separately for each group of pictures having same values of temporal scalability and inter-layer coding dependency.

According to an embodiment, in response to decoding a reference picture located on a particular temporal level, a previous reference picture on the same temporal level is marked as unused for reference.

According to an embodiment, the decoded reference pictures on temporal level 0 are marked as long-term reference pictures.

According to an embodiment, memory management control operations tackling long-term reference pictures are prevented for the decoded pictures on temporal levels greater than 0.

According to an embodiment, memory management control operations tackling short-term pictures are restricted only for the decoded pictures on the same or higher temporal level than the current picture.

According to a second aspect, there is provided a method of decoding a scalable video data stream comprising a base layer and at least one enhancement layer, the method comprising: decoding signalling information received with a scalable data stream, said signalling information including information about temporal scalability and inter-layer coding dependencies of pictures on said layers; decoding the pictures on said layers in decoding order; and buffering the decoded pictures according to an independent sliding window process such that said process is operated separately for each group of pictures having same values of temporal scalability and inter-layer coding dependency.

The arrangement according to the invention provides significant advantages. A basic idea underlying the invention is that if pictures only from the base layer of a scalable video stream are decoded, then a decoding algorithm compliant with prior known methods is used, but if pictures from upper layers having reference pictures on lower layers, e.g. on the base layer, are decoded, then a new, more optimized decoding algorithm is used. With the new sliding window process for buffering the decoded pictures, number of buffered decoded pictures can be reduced significantly, since no “non-existing” frames are generated in the buffer. Another advantage is that the new sliding window process enables to keep the reference picture lists identical in both H.264/AVC base layer decoding and in SVC base layer decoding. Furthermore, a new memory management control operation introduced along the new sliding window process provides the advantage that temporal level upgrade positions can be easily identified. Moreover, the reference pictures at certain temporal levels can be marked as “unused for reference” without referencing them explicitly.

The further aspects of the invention include various apparatuses arranged to carry out the inventive steps of the above methods.

### BRIEF DESCRIPTION OF THE DRAWINGS AND THE ANNEXES

In the following, various embodiments of the invention will be described in more detail with reference to the appended drawings, in which

FIG. 1 shows a temporal segment of an exemplary scalable video stream;

FIG. 2 shows a prediction reference relationship of the scalable video stream of FIG. 1;

FIG. 3a shows an example of a video sequence coded using hierarchical temporal scalability;

FIG. 3b shows the example sequence of FIG. 3a in decoding order;

FIG. 3c shows the example sequence of FIG. 3a in output order delayed enough to be recovered in the decoder;

FIG. 4 shows the contents of the decoded picture buffer according to prior art;

FIG. 5 shows the contents of the decoded picture buffer according to an embodiment;

FIG. 6 shows an encoding device according to an embodiment in a simplified block diagram;

FIG. 7 shows a decoding device according to an embodiment in a simplified block diagram;

FIG. 8 shows a block diagram of a mobile communication device according to a preferred embodiment;

FIG. 9 shows a video communication system, wherein the invention is applicable;

FIG. 10 shows a multimedia content creation and retrieval system;

FIG. 11 shows a typical sequence of operations carried out by a multimedia clip editor;

FIG. 12 shows typical sequence of operations carried out by a multimedia server;

FIG. 13 shows typical sequence of operations carried out by a multimedia retrieval client;

FIG. 14 shows an IP multicasting arrangement where each router can strip the bitstream according to its capabilities;

Annex 1 discloses Reference picture making in SVC, proposed MMCO changes to specification text; and

Annex 2 discloses Reference picture making in SVC, proposed EIDR changes to specification text.

### DETAILED DESCRIPTION OF THE INVENTION

The invention is applicable to all video coding methods using scalable video coding. Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC). In addition, there are efforts working towards new video coding standards. One is the development of the scalable video coding (SVC) standard, which will become the scalable extension to H.264/AVC. The SVC standard is currently being developed under the JVT, the joint video team formed by ITU-T VCEG and ISO/IEC MPEG. The second effort is the development of China video coding standards organized by the China Audio Visual coding Standard Work Group (AVS).

The following is an exemplary illustration of the invention using the scalable video coding SVC as an example. The SVC coding will be described to a level of detail considered satisfactory for understanding the invention and its preferred embodiments. For a more detailed description of the implementation of SVC, reference is made to the SVC standard, the latest specification of which is described in JVT-Q202, 17^{th} JVT meeting, Nice, France, October 2005.

A scalable bit stream contains at least two scalability layers, the base layer and one or more enhancement layers. If one scalable bit stream contains a plurality of scalability layers, it then has the same number of alternatives for decoding and playback. Each layer is a decoding alternative. Layer 0, the base layer, is the first decoding alternative. The bitstream composed of layer 1, i.e. the first enhancement layer, and layer 0 is the second decoding alternative, etc. In general, the bitstream composed of an enhancement layer and any lower layers in the hierarchy from which successful decoding of the enhancement layer depends on, is a decoding alternative.

The scalable layer structure in the draft SVC standard is characterized by three variables, namely temporal_level, dependency_id and quality_level, which are signalled in the bitstream or can be derived according to the specification. Temporal_level is used to indicate temporal scalability or frame rate. A layer consisted of pictures of a smaller temporal_level value has a smaller frame rate. Dependency_id is used to indicate the inter-layer coding dependency hierarchy. At any temporal location, a picture of a smaller dependency_id value may be used for inter-layer prediction for coding of a picture with a larger dependency_id value. Quality_level is used to indicate FGS layer hierarchy. At any temporal location and with identical dependency_id value, an FGS picture with quality_level value equal to QL uses the FGS picture or base quality picture (the non-FGS picture when QL-1=0) with quality_level value equal to QL-1 for inter-layer prediction.

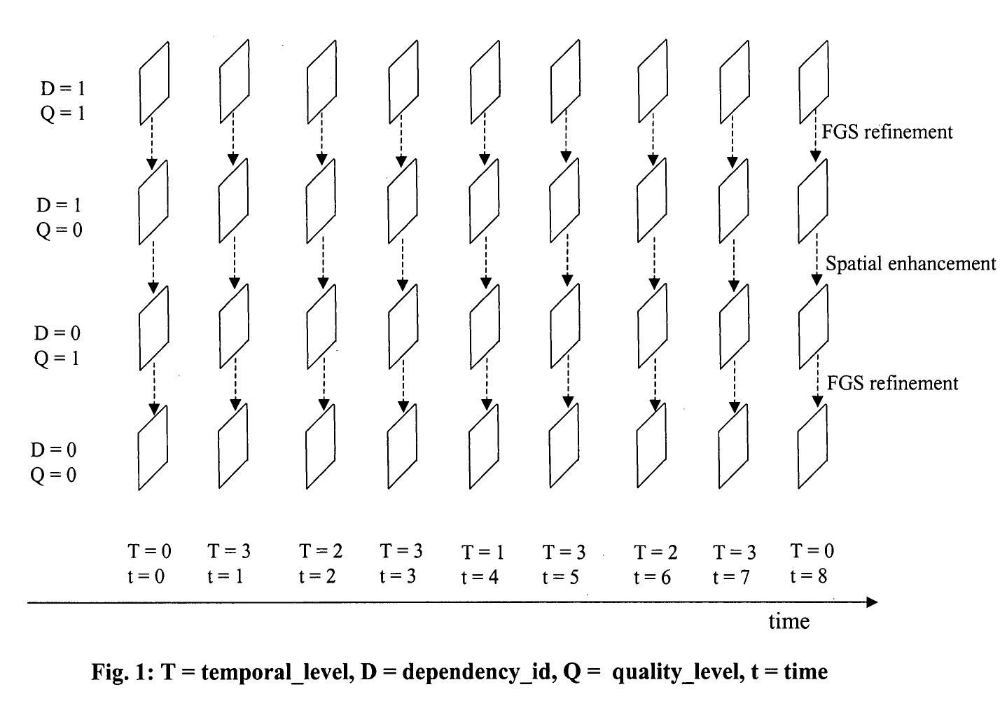

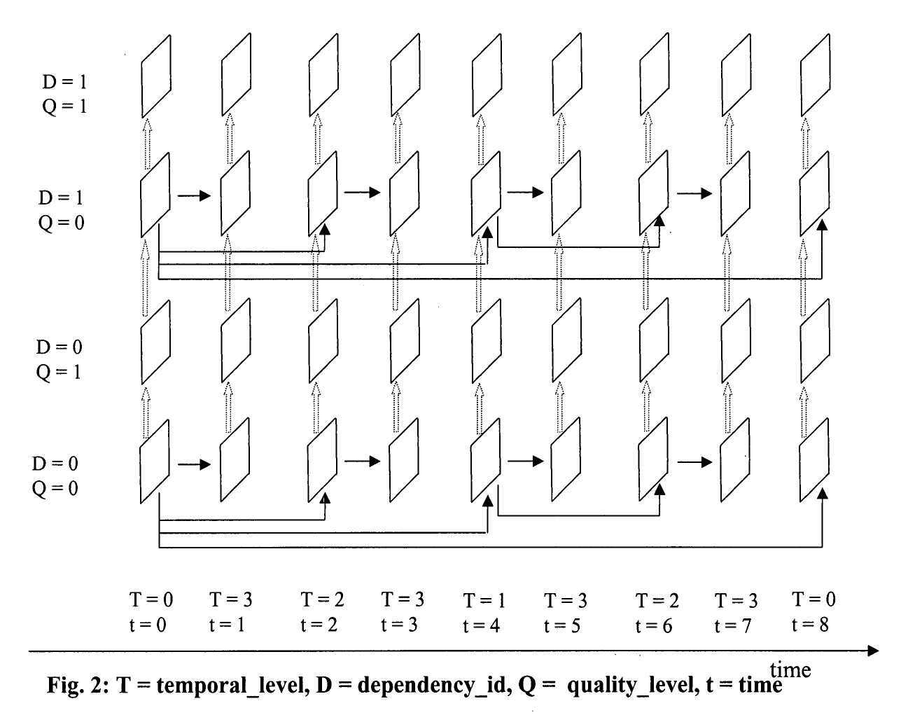

FIG. 1 shows a temporal segment of an exemplary scalable video stream with the displayed values of the three variables. Note that the time values are relative, i.e. time=0 does not necessarily mean the time of the first picture in display order in the bitstream. A typical prediction reference relationship of the example is shown in FIG. 2, where solid arrows indicate the inter prediction reference relationship in the horizontal direction, and dashed block arrows indicate the inter-layer prediction reference relationship. The pointed-to instance uses the instance in the other direction for prediction reference.

In this application, the term “layer” refers to a set of pictures having identical values of temporal_level, dependency_id and quality_level, respectively. To decode and playback an enhancement layer, typically the lower layers including the base layer should also be available, because the lower layers may be used for inter-layer prediction, directly or indirectly, in coding of the enhancement layer. For example, in FIGS. 1 and 2, the pictures with (t, T, D, Q) equal to (0, 0, 0, 0) and (8, 0, 0, 0) belong to the base layer, which can be decoded independently of any enhancement layers. The picture with (t, T, D, Q) equal to (4, 1, 0, 0) belongs to an enhancement layer that doubles the frame rate of the base layer, and the decoding of this layer needs the presence of the base layer pictures. The pictures with (t, T, D, Q) equal to (0, 0, 0, 1) and (8, 0, 0, 1) belong to an enhancement layer that enhances the quality and bitrate of the base layer in the FGS manner, and the decoding of this layer also needs the presence of the base layer pictures.

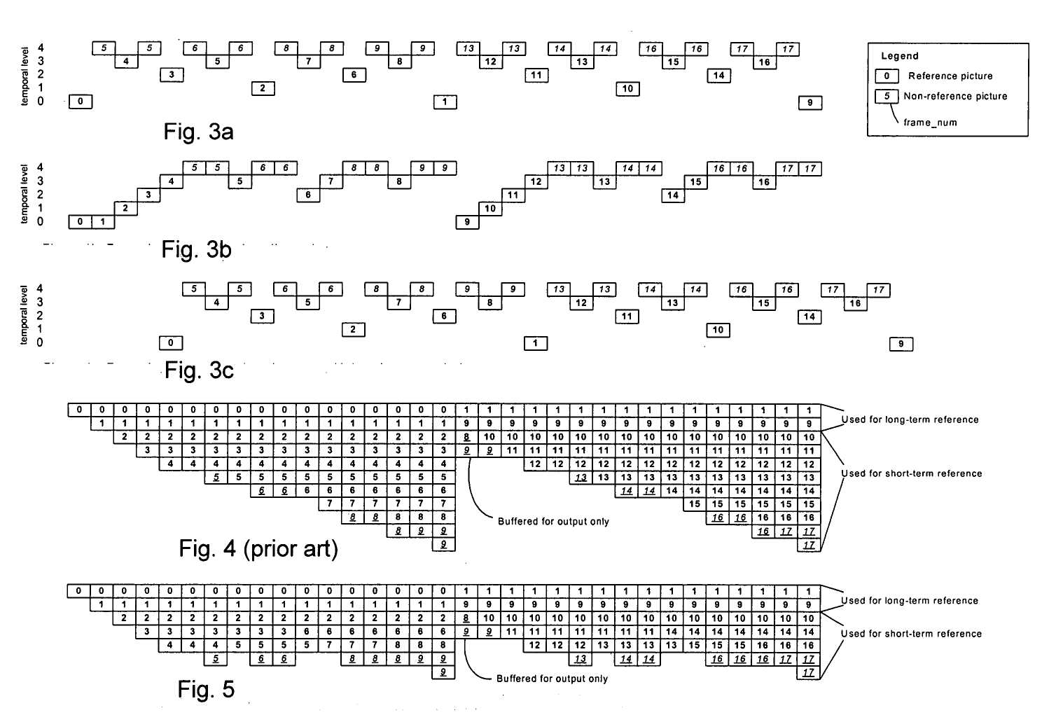

The drawbacks of the prior art solutions and basic idea underlying the present invention will be next illustrated by referring to FIGS. 3-5. FIG. 3a presents an example of a video sequence coded using hierarchical temporal scalability with five temporal levels 0-4. The output order of pictures in FIG. 3a runs from left to right. Pictures are labeled with their frame number value (frame_num). Non-reference pictures, i.e. pictures to which no other picture refers to, reside in the highest temporal level and printed in italics. The inter prediction dependencies of the reference pictures are the following: Picture 0 is an IDR picture. The reference picture of picture 1 is picture 0. The reference pictures for picture 9 are pictures 0 and 1. The reference pictures in any picture at temporal level 1 or above are the closest reference pictures in output order in any lower temporal level. For example, the reference pictures of picture 2 are pictures 0 and 1, and the reference pictures of picture 3 are pictures 0 and 2.

FIG. 3b presents the example sequence in decoding order, and FIG. 3c presents the example sequence in output order delayed by such an amount that the output order can be recovered in the decoder.

FIG. 4 presents the contents of the decoded picture buffer according to the current SVC. The same buffering scheme applies in H.264/AVC also. Pictures 0, 1 and 9 on the base layer are marked as “used for long-term reference” when they are decoded (picture 9 replaces picture 0 as a long-term reference picture). All the other pictures are marked according to the sliding window decoded reference picture marking process, because they may be subject to removal and must therefore be handled identically to the corresponding “non-existing” frames that are generated in the decoder as the response of the removal. The process generates “non-existing” frames marked as “used for short-term reference” for missing values of frame_num (that correspond to the removed reference pictures). Pictures, which have underlined frame numbers, are marked as “unused for reference” but are buffered to arrange them in output order.

In the current SVC, the syntax element dependency_id signaled in the bitstream is used to indicate the coding dependencies of different scalable layers. The sliding window decoded reference picture marking process is performed for all pictures having an equal value of dependency_id. This results in buffering non-required decoded pictures, which reserves memory space needlessly. It can be seen in the example of FIG. 4 that the number of buffered decoded pictures peaks at 11, which significantly exceeds a typical size of decoded picture buffer in the levels specified in H.264/AVC (which is about 5 pictures when the picture size is according to a typical operation point of a level). It should also be noted that the maximum number of temporal levels in SVC is 8 (in this example only 5 levels were used), which would require even a significantly higher number of reference pictures in the decoded picture buffer.

Now according to an aspect of the invention, the operation of the sliding window decoded reference picture marking process is altered such that, instead of operating the process for all pictures having an equal value of dependency_id, an independent sliding window process is operated per each combination of dependency_id and temporal_level values. Thus, decoding of a reference picture of a certain temporal_level causes marking of a past reference picture with the same value of temporal_level as “unused for reference”. Furthermore, the decoding process for gaps in frame_num value is not used and therefore “non-existing” frames are not generated. Consequently, considerable savings in the space allocated for the decoded picture buffer can be achieved. As for examples of the modifications required for the syntax and semantics of different messages and information fields of the SVC standard, a reference is made to: “Reference picture making in SVC, proposed MMCO changes to specification text”, which is included herewith as Annex 1, and to “Reference picture making in SVC, proposed EIDR changes to specification text”, which is included herewith as Annex 2.

FIG. 5 presents the contents of the decoded picture buffer of the example given in FIGS. 3a to 3c according to the altered process. In the example, a sliding window buffer equal to 1 frame is reserved per each temporal level above the base layer and the pictures in temporal layer 0 are stored as long-term reference pictures (identically to the example in FIG. 4). It can be seen that the maximum number of buffered decoded pictures is reduced to 7.

According to an embodiment, the sequence parameter set of the SVC is extended with a flag: temporal_level_always_zero_flag, which explicitly identifies the SVC streams that do not use multiple temporal levels. If the flag is set, the reference picture marking process is identical compared to H.264/AVC with the restriction that only pictures with a particular value of dependency_id are considered.

According to an embodiment, as the desired size of the sliding window for each temporal level may differ, the sequence parameter set is further appended to contain the number of reference frames for each temporal level (num_ref_frames_in_temporal_level[i] syntax element). Long-term reference pictures are considered to reside in temporal level 0. Thus, the size of the sliding window is equal to num_ref_frames_in_temporal_level[i] for temporal levels 1 and above and (num_ref_frames_in_temporal_level[0]—number of long-term reference frames) for temporal level 0.

It is apparent that it is advantageous to keep the base layer (i.e. the pictures for which dependency_id and temporal_level are inferred to be equal to 0) compliant with H.264/AVC. According to an embodiment, reference picture lists shall be identical in H.264/AVC base layer decoding and in SVC base layer decoding regardless whether pictures with temporal_level greater than 0 are present. This is the basic principle in maintaining the H.264/AVC compatibility.

Accordingly, from the viewpoint of encoding, when a scalable video data stream comprising a base layer and at least one enhancement layer is generated, it is also necessary to generate and encode a reference picture list for prediction, which reference picture list enables creation of the same picture references, irrespective of using a first decoded reference picture marking algorithm for a data stream modified to comprise only the base layer, or a second decoded reference picture marking algorithm for a data stream comprising at least part of said at least one enhancement layer.

As the pictures in temporal levels greater than 0 are not present in H.264/AVC baseline decoding, “non-existing” frames are generated for the missing values of frame_num. According to an embodiment, the sliding window process is operated for each value of temporal level independently, and therefore “non-existing” frames are not generated. Reference picture lists for the base layer pictures are therefore generated with the following procedure:
All reference pictures used for inter prediction are explicitly reordered and they are located in the head of the reference picture lists (RefPicList0 and RefPicList1).
The number of active reference picture indices (num_ref_idx_I0_active_minus1 and num_ref_idx_I1_active_minus1) is set equal to the number of reference picture used for inter prediction. This is not be absolutely necessary, but helps decoders to detect potential errors.

It is also ensured that memory management control operations are not carried out for such base layer pictures in the SVC decoding process that would not be present in the H.264/AVC decoding process. Thus, memory management control operations are advantageously restricted to those short-term reference pictures having temporal_layer equal to 0 that would be present in the decoded picture buffer if the sliding window decoded reference picture marking process were in use.

In practice, it is often necessary to mark decoded reference pictures in temporal level 0 as long-term pictures when they are decoded. In the SVC, this is preferably carried out with a memory management control operation (MMCO) 6, which is defined more in detail in the SVC specification.

According to an embodiment, higher temporal levels can be removed without affecting the decoding of the remaining bitstream. Thus, as with the sub-sequence design of H.264/AVC, further defined in subclause D.2.11 of H.264/AVC, the occurrence of memory management control operations is preferably restricted according to the following embodiments:
Memory management control operations tackling long-term reference pictures (i.e. memory management control operations 2, 3, or 4 defined in the SVC specification) are not allowed when temporal level is greater than 0. If this restriction were not present, then the size of the sliding window of temporal level 0 could depend on the presence or absence of the picture in temporal level greater than 0. If the memory management control operation were present on such higher layer (above layer 0), a picture on the layer would not be freely disposable.
Memory management control operations for marking short-term pictures unused for reference are allowed to concern only pictures in the same or higher temporal level than the current picture. =p As already mentioned, “non-existing” frames are not generated according to the invention. In H.264/AVC, “non-existing” frames take part in the initialization process for reference picture lists and hence the indices for existing reference frames are correct in the initial lists.

According to an embodiment, to produce correct initial reference picture lists for temporal level 1 and the levels above, only those pictures which are in the same or lower temporal level, compared to the temporal level of the current picture, are considered in the initialization process.

An EIDR picture is proposed in JVT-Q065, 17^{th} JVT meeting, Nice, France, October 2005. An EIDR picture causes the decoding process to mark all short-term reference pictures in the same layer as “unused for reference” immediately after decoding the EIDR picture. According to an embodiment, an EIDR picture is generated for each picture enabling an upgrade from a lower temporal level to the temporal level of the picture. Otherwise, if pictures having temporal_level equal to constant C and occurring prior to the EIDR picture are not present in a modified bitstream, the initial reference picture lists may differ in the encoder (which generated the original bitstream in which the pictures are present) and in the decoder decoding the modified bitstream. Again, Annex 2 is referred to regarding examples of the modifications required by the use of an EIDR picture for the syntax and semantics of different messages and information fields of the SVC standard.

According to an embodiment, as an alternative to the use of the EIDR picture, a new memory management control operation (MMCO) is provided, which marks all reference pictures of certain values of temporal_level as “unused for reference”. The MMCO syntax includes the target temporal level, which must be equal to or greater than the temporal level of the current picture. The reference pictures at and above the target temporal level are marked as “unused for reference”. Again, Annex 1 is referred to regarding examples of the modifications required by the new MMCO (MMCO 7) for the syntax and semantics of different messages and information fields of the SVC standard.

An advantage of the new MMCO is that temporal level upgrade positions can be easily identified. If the currently processed temporal level is equal to n, then the processing of the temporal level n+1 can start from a picture in temporal level n+1 that contains the proposed MMCO in which the target temporal level is n+1. A further advantage is that the reference pictures at certain temporal levels can be marked as “unused for reference” without referencing them explicitly. Since “non-existing” frames are not generated, the new MMCO is therefore needed to remove frames from the decoded picture buffer earlier than the sliding window decoded reference picture marking process would do. Early removal may be useful to save DPB buffer space even further with some temporal reference picture hierarchies. Yet another advantage of the new MMCO is that when temporal level is upgraded in the bitstream for decoding and the original encoded bitstream contains a constant number of temporal levels, the reference picture marking for temporal levels at and above the level to upgrade to must be reset to “unused for reference”. Otherwise, the reference picture marking and initial reference picture lists in the encoder and decoder would differ. It is therefore necessary to include the new MMCO in all pictures in which temporal level upgrade is possible.

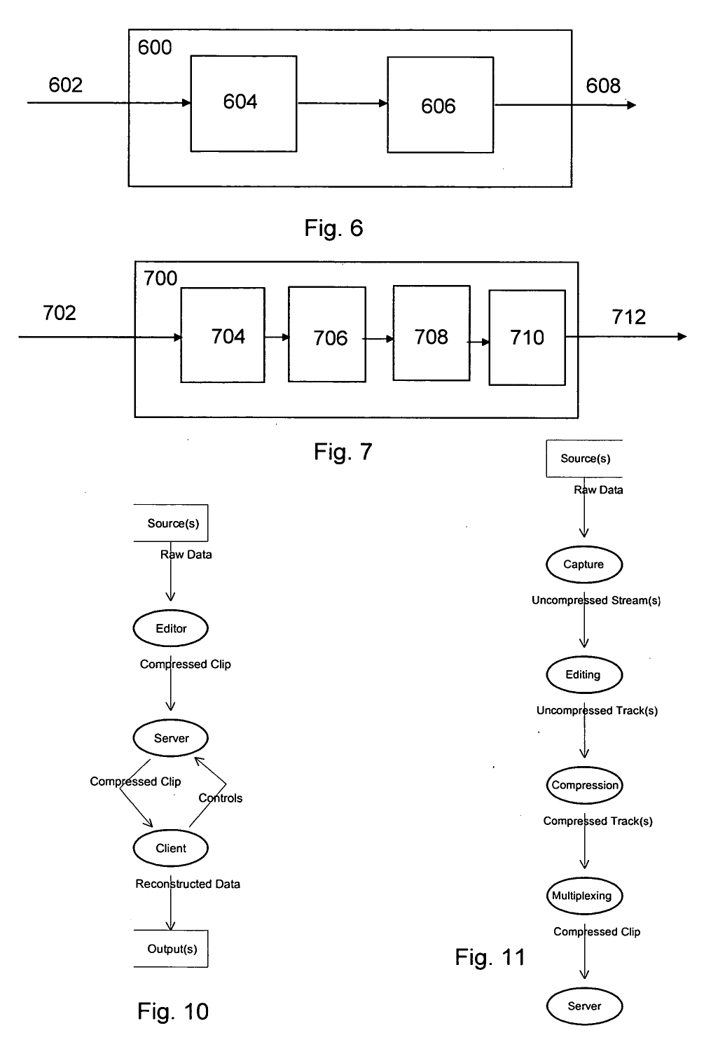

FIG. 6 illustrates an encoding device according to an embodiment, wherein the encoding device 600 receives a raw data stream 602, which is encoded and one or more layers are produced by the scalable data encoder 604 of the encoder 600. The scalable data encoder 604 generates and encodes a reference picture list for prediction, which reference picture list enables creation of the same picture references in the decoding phase, irrespective of whether the first or the second decoded reference picture marking algorithm is used for decoding the data stream. The scalable data encoder 604 inserts reference picture list to a message forming unit 606, which may be e.g. an access unit composer. The encoded data stream 608 is output from the encoder 600.

FIG. 7 illustrates a decoding device according to an embodiment, wherein the decoding device 700 receives the encoded data stream 702 via a receiver 704. The information of temporal scalability and inter- layer coding dependencies of pictures on said layers is extracted from the data stream in a message deforming unit 706, which may be e.g. an access unit decomposer. A decoder 708 then decodes the pictures on said layers in decoding order and the decoded pictures are then buffered in a buffer memory 710 and decoded reference pictures are marked as “used for reference” or “unused for reference” according to an independent sliding window process such that said process is operated separately for each group of pictures having same values of temporal scalability and inter-layer coding dependency. The decoded data stream 712 is output from the decoder 700.

The different parts of video-based communication systems, particularly terminals, may comprise properties to enable bidirectional transfer of multimedia streams, i.e. transfer and reception of streams. This allows the encoder and decoder to be implemented as a video codec comprising the functionalities of both an encoder and a decoder.

It is to be noted that the functional elements of the invention in the above video encoder, video decoder and terminal can be implemented preferably as software, hardware or a combination of the two. The coding and decoding methods of the invention are particularly well suited to be implemented as computer software comprising computer-readable commands for carrying out the functional steps of the invention. The encoder and decoder can preferably be implemented as a software code stored on storage means and executable by a computer-like device, such as a personal computer (PC) or a mobile station (MS), for achieving the coding/decoding functionalities with said device. Other examples of electronic devices, to which such coding/decoding functionalities can be applied, are personal digital assistant devices (PDAs), set-top boxes for digital television systems, gaming consoles, media players and televisions.

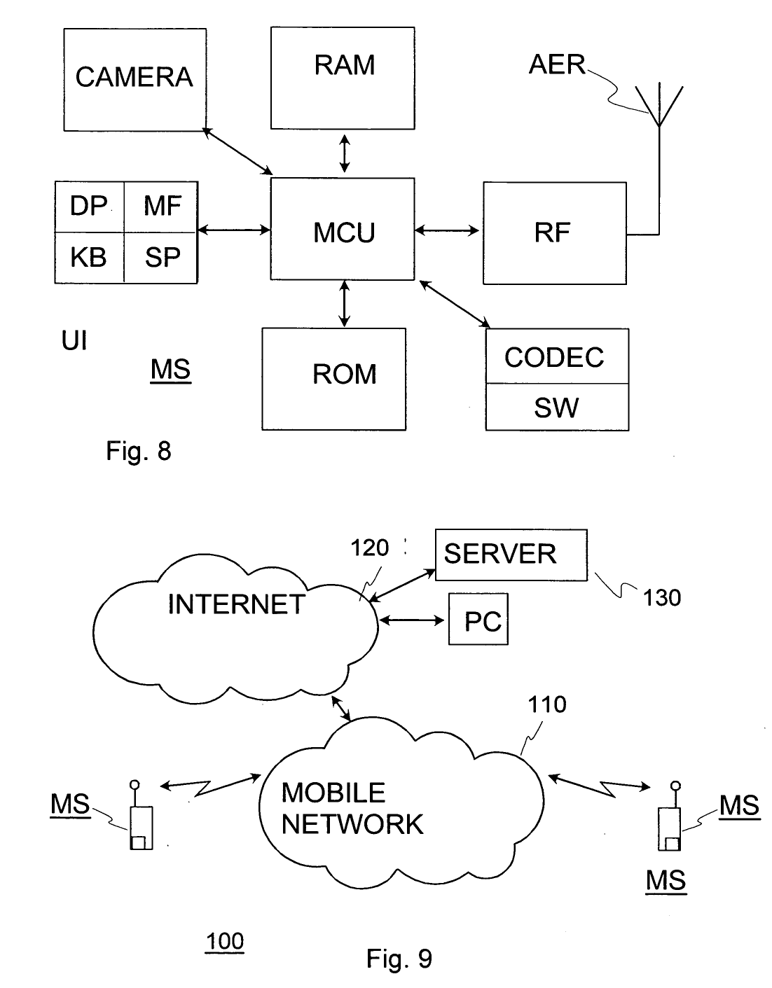

FIG. 8 shows a block diagram of a mobile communication device MS according to the preferred embodiment of the invention. In the mobile communication device, a Master Control Unit MCU controls blocks responsible for the mobile communication device's various functions: a Random Access Memory RAM, a Radio Frequency part RF, a Read Only Memory ROM, video codec CODEC and a User Interface UI. The user interface comprises a keyboard KB, a display DP, a speaker SP and a microphone MF. The MCU is a microprocessor, or in alternative embodiments, some other kind of processor, for example a Digital Signal Processor. Advantageously, the operating instructions of the MCU have been stored previously in the ROM memory. In accordance with its instructions (i.e. a computer program), the MCU uses the RF block for transmitting and receiving data over a radio path via an antenna AER. The video codec may be either hardware based or fully or partly software based, in which case the CODEC comprises computer programs for controlling the MCU to perform video encoding and decoding functions as required. The MCU uses the RAM as its working memory. The mobile communication device can capture motion video by the video camera, encode and packetize the motion video using the MCU, the RAM and CODEC based software. The RF block is then used to exchange encoded video with other parties.

FIG. 9 shows video communication system 100 comprising a plurality of mobile communication devices MS, a mobile telecommunications network 110, the Internet 120, a video server 130 and a fixed PC connected to the Internet. The video server has a video encoder and can provide on-demand video streams such as weather forecasts or news.

Network traffic through the Internet is based on a transport protocol called the Internet Protocol (IP). IP is concerned with transporting data packets from one location to another. It facilitates the routing of packets through intermediate gateways, that is, it allows data to be sent to machines that are not directly connected in the same physical network. The unit of data transported by the IP layer is called an IP datagram. The delivery service offered by IP is connectionless, that is IP datagrams are routed around the Internet independently of each other. Since no resources are permanently committed within the gateways to any particular connection, the gateways may occasionally have to discard datagrams because of lack of buffer space or other resources. Thus, the delivery service offered by IP is a best effort service rather than a guaranteed service.

Internet multimedia is typically streamed over the User Datagram Protocol (UDP), the Transmission Control Protocol (TCP) or the Hypertext Transfer Protocol (HTTP).

UDP is a connectionless lightweight transport protocol. It offers very little above the service offered by IP. Its most important function is to deliver datagrams between specific transport endpoints. Consequently, the transmitting application has to take care of how to packetize data to datagrams. Headers used in UDP contain a checksum that allows the UDP layer at the receiving end to check the validity of the data. Otherwise, degradation of IP datagrams will in turn affect UDP datagrams. UDP does not check that the datagrams have been received, does not retransmit missing datagrams, nor does it guarantee that the datagrams are received in the same order as they were transmitted.

UDP introduces a relatively stable throughput having a small delay since there are no retransmissions. Therefore it is used in retrieval applications to deal with the effect of network congestion and to reduce delay (and jitter) at the receiving end. However, the client must be able to recover from packet losses and possibly conceal lost content. Even with reconstruction and concealment, the quality of a reconstructed clip suffers somewhat. On the other hand, playback of the clip is likely to happen in real-time without annoying pauses. Firewalls, whether in a company or elsewhere, may forbid the usage of UDP because it is connectionless.

TCP is a connection-orientated transport protocol and the application using it can transmit or receive a series of bytes with no apparent boundaries as in UDP. The TCP layer divides the byte stream into packets, sends the packets over an IP network and ensures that the packets are error-free and received in their correct order. The basic idea of how TCP works is as follows. Each time TCP sends a packet of data, it starts a timer. When the receiving end gets the packet, it immediately sends an acknowledgement back to the sender. When the sender receives the acknowledgement, it knows all is well, and cancels the timer. However, if the IP layer loses the outgoing segment or the return acknowledgement, the timer at the sending end will expire. At this point, the sender will retransmit the segment. Now, if the sender waited for an acknowledgement for each packet before sending the next one, the overall transmission time would be relatively long and dependent on the round-trip delay between the sender and the receiver. To overcome this problem, TCP uses a sliding window protocol that allows several unacknowledged packets to be present in the network. In this protocol, an acknowledgement packet contains a field filled with the number of bytes the client is willing to accept (beyond the ones that are currently acknowledged). This window size field indicates the amount of buffer space available at the client for storage of incoming data. The sender may transmit data within the limit indicated by the latest received window size field. The sliding window protocol means that TCP effectively has a slow start mechanism. At the beginning of a connection, the very first packet has to be acknowledged before the sender can send the next one. Typically, the client then increases the window size exponentially. However, if there is congestion in the network, the window size is decreased (in order to avoid congestion and to avoid receive buffer overflow). The details how the window size is changed depend on the particular TCP implementation in use.

A multimedia content creation and retrieval system is shown in FIG. 10. The system has one or more media sources, for example a camera and a microphone. Alternatively, multimedia content can also be synthetically created without a natural media source, for example animated computer graphics and digitally generated music. In order to compose a multimedia clip consisting of different media types, such as video, audio, text, images, graphics and animation, raw data captured from the sources are edited by an editor. Typically the storage space taken up by raw (uncompressed) multimedia data is huge. It can be megabytes for a video sequence, which can include a mixture of different media, for example animation. In order to provide an attractive multimedia retrieval service over low bit rate channels, for example 28.8 kbps and 56 kbps, multimedia clips are compressed in the editing phase. This typically occurs off-line. The clips are then handed to a multimedia server. Typically, a number of clients can access the server over one or more networks. The server is able to respond to the requests presented by the clients. The main task of the server is to transmit a desired multimedia clip to the client, which the client decompresses and plays. During playback, the client utilizes one or more output devices, such as a screen and a loudspeaker. In some circumstances, clients are able to start playback while data are still being downloaded.

It is convenient to deliver a clip by using a single channel, which provides a similar quality of service for the entire clip. Alternatively different channels can be used to deliver different parts of a clip, for example sound on one channel and pictures on another. Different channels may provide different qualities of service. In this context, quality of service includes bit rate, loss or bit error rate and transmission delay variation.

In order to ensure multimedia content of a sufficient quality is delivered, it is provided over a reliable network connection, such as TCP, which ensures that received data are error-free and in the correct order. Lost or corrupted protocol data units are retransmitted. Consequently, the channel throughput can vary significantly. This can even cause pauses in the playback of a multimedia stream whilst lost or corrupted data are retransmitted. Pauses in multimedia playback are annoying.

Sometimes retransmission of lost data is not handled by the transport protocol but rather by some higher-level protocol. Such a protocol can select the most vital lost parts of a multimedia stream and request the retransmission of those. The most vital parts can be used for prediction of other parts of the stream, for example.

Descriptions of the elements of the retrieval system, namely the editor, the server and the client, are set out below.

A typical sequence of operations carried out by the multimedia clip editor is shown in FIG. 11. Raw data are captured from one or more data sources. Capturing is done using hardware, device drivers dedicated to the hardware and a capturing application, which controls the device drivers to use the hardware. Capturing hardware may consist of a video camera connected to a PC video grabber card, for example. The output of the capturing phase is usually either uncompressed data or slightly compressed data with irrelevant quality degradations when compared to uncompressed data. For example, the output of a video grabber card could be in an uncompressed YUV 4:2:0 format or in a motion-JPEG format. The YUV colour model and the possible sub-sampling schemes are defined in Recommendation ITU-R BT.601-5 “Studio Encoding Parameters of Digital Television for Standard 4:3 and Wide-Screen 16:9 Aspect Ratios”. Relevant digital picture formats such as CIF, QCIF and SQCIF are defined in Recommendation ITU-T H.261 “Video Codec for Audiovisual Services at p×64 kbits” (section 3.1 “Source Formats).

During editing separate media tracks are tied together in a single timeline. It is also possible to edit the media tracks in various ways, for example to reduce the video frame rate. Each media track may be compressed. For example, the uncompressed YUV 4:2:0 video track could be compressed using ITU-T recommendation H.263 for low bit rate video coding. If the compressed media tracks are multiplexed, they are interleaved so that they form a single bitstream. This clip is then handed to the multimedia server. Multiplexing is not essential to provide a bitstream. For example, different media components such as sounds and images may be identified with packet header information in the transport layer. Different UDP port numbers can be used for different media components.

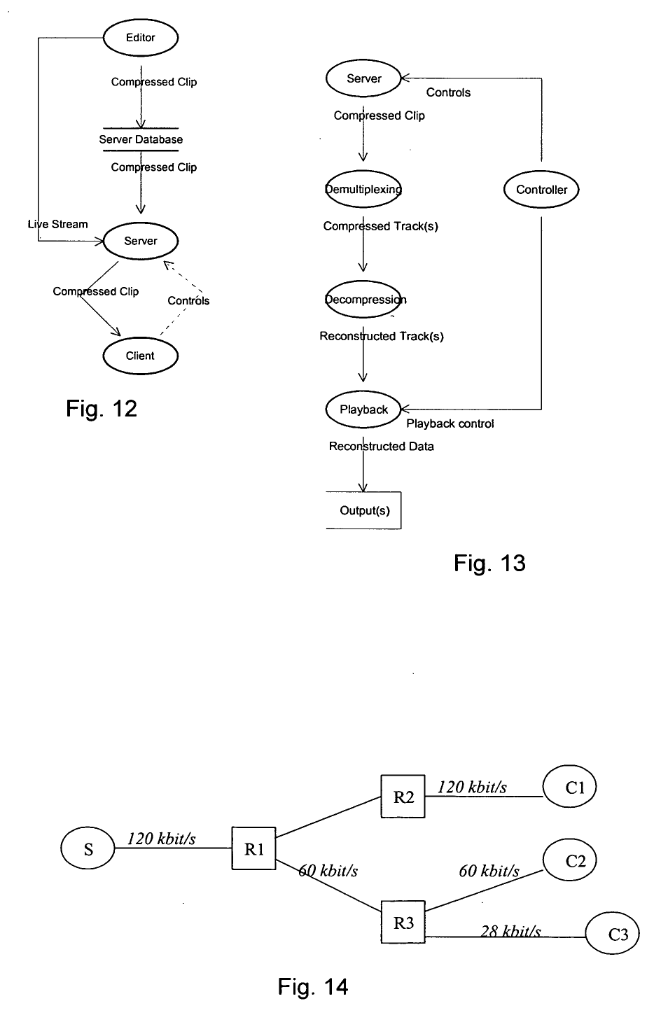

A typical sequence of operations carried out by the multimedia server is shown in FIG. 12. Typically multimedia servers have two modes of operation; they deliver either pre-stored multimedia clips or a live (real-time) multimedia stream. In the first mode, clips are stored in a server database, which is then accessed on-demand by the server. In the second mode, multimedia clips are handed to the server as a continuous media stream that is immediately transmitted to clients. Clients control the operation of the server by an appropriate control protocol being at least able to select a desired media clip. In addition, servers may support more advanced controls. For example, clients may be able to stop the transmission of a clip, to pause and resume transmission of a clip, and to control the media flow in case of a varying throughput of the transmission channel in which case the server must dynamically adjust the bitstream to fit into the available bandwidth.

A typical sequence of operations carried out by the multimedia retrieval client is shown in FIG. 13. The client gets a compressed and multiplexed media clip from a multimedia server. The client demultiplexes the clip in order to obtain separate media tracks. These media tracks are then decompressed to provide reconstructed media tracks which are played out with output devices. In addition to these operations, a controller unit is provided to interface with end-users, that is to control playback according to end-user input and to handle client-server control traffic. It should be noted that the demultiplexing-decompression-playback chain can be done on a first part of the clip while still downloading a subsequent part of the clip. This is commonly referred to as streaming. An alternative to streaming is to download the whole clip to the client and then demultiplex it, decompress it and play it.

A typical approach to the problem of varying throughput of a channel is to buffer media data in the client before starting the playback and/or to adjust the transmitted bit rate in real-time according to channel throughput statistics.

Scalability in terms of bitrate, decoding complexity, and picture size is a desirable property for heterogeneous and error prone environments. This property is desirable in order to counter limitations such as constraints on bit rate, display resolution, network throughput, and decoder complexity.

Scalability can be used to improve error resilience in a transport system where layered coding is combined with transport prioritisation. The term transport prioritisation here refers to various mechanisms to provide different qualities of service in transport, including unequal error protection, to provide different channels having different error/loss rates. Depending on their nature, data are assigned differently, for example, the base layer may be delivered through a channel with high degree of error protection, and the enhancement layers may be transmitted through more error-prone channels.

In multi-point and broadcast multimedia applications, constraints on network throughput may not be foreseen at the time of encoding. Thus, a scalable bitstream should be used. FIG. 14 shows an IP multicasting arrangement where each router can strip the bitstream according to its capabilities. It shows a server S providing a bitstream to a number of clients C. The bitstreams are routed to the clients by routers R. In this example, the server is providing a clip which can be scaled to at least three bit rates, 120 kbit/s, 60 kbit/s and 28 kbit/s.

If the client and server are connected via a normal uni-cast connection, the server may try to adjust the bit rate of the transmitted multimedia clip according to the temporary channel throughput. One solution is to use a layered bit stream and to adapt to bandwidth changes by varying the number of transmitted enhancement layers.

It should be evident that the present invention is not limited solely to the above-presented embodiments, but it can be modified within the scope of the appended claims.

What is claimed is:

1. A method of decoding a scalable video data stream comprising a base layer and at least one enhancement layer, the method comprising:
decoding pictures of the video data stream according to a first decoding algorithm, if pictures only from the base layer are to be decoded; and
decoding pictures of the video data stream according to a second decoding algorithm, if pictures from the base layer and from at least one enhancement layer are to be decoded.

2. The method according to claim 1, wherein
the steps of decoding pictures of the video data stream include a process of marking decoded reference pictures.

3. The method according to claim 1, wherein
said first decoding algorithm is compliant with a sliding window decoded reference picture marking process according to H.264/AVC.

4. The method according to claim 1, wherein
said second decoding algorithm carries out a sliding window decoded reference picture marking process, which is operated separately for each group of pictures having same values of temporal scalability and inter-layer coding dependency.

5. The method according to claim 4, further comprising:
in response to decoding a reference picture located on a particular temporal level, marking a previous reference picture on the same temporal level as unused for reference.

6. The method according to claim 4, further comprising:
marking the decoded reference pictures on temporal level 0 as long-term reference pictures.

7. The method according to claim 6, further comprising:
preventing memory management control operations tackling long-term reference pictures for the decoded pictures on temporal levels greater than 0.

8. The method according to claim 6, further comprising:
restricting memory management control operations tackling short-term pictures only for the decoded pictures on the same or higher temporal level than the current picture.

9. A method of decoding a scalable video data stream comprising a base layer and at least one enhancement layer, the method comprising:
decoding signalling information received with a scalable data stream, said signalling information including information about temporal scalability and inter-layer coding dependencies of pictures on said layers;
decoding the pictures on said layers in decoding order; and
buffering the decoded pictures according to an independent sliding window process such that said process is operated separately for each group of pictures having same values of temporal scalability and inter-layer coding dependency.

10. A video decoder comprising:
a decoder configured for decoding pictures of a scalable video data stream comprising a base layer and at least one enhancement layer, said decoding according to a first decoding algorithm, if pictures only from the base layer are to be decoded, and
configured for decoding pictures of the video data stream according to a second decoding algorithm, if pictures from the base layer and from at least one enhancement layer are to be decoded.

11. A video decoder comprising:
a decoder configured for decoding signalling information received with a scalable data stream comprising a base layer and at least one enhancement layer, said signalling information including information about temporal scalability and inter-layer coding dependencies of pictures on said layers, and
configured for decoding the pictures on said layers in decoding order; and
a buffer for buffering the decoded pictures according to an independent sliding window process such that said process is operated separately for each group of pictures having same values of temporal scalability and inter-layer coding dependency.

12. An electronic device comprising:
a decoder for decoding pictures of a video data stream comprising a base layer and at least one enhancement layer, said decoding according to a first decoding algorithm, if pictures only from the base layer are to be decoded, and
configured for decoding pictures of the video data stream according to a second decoding algorithm, if pictures from the base layer and from at least one enhancement layer are to be decoded.

13. The electronic device according to claim 12, wherein said decoder configured for decoding pictures of the video data stream according to the second decoding algorithm further is configured for decoding signalling information received with a scalable data stream, said signalling information including information about temporal scalability and inter-layer coding dependencies of pictures on said layers, and further configured for decoding the pictures on said layers in decoding order; and further comprises a buffer for buffering the decoded pictures according to an independent sliding window process such that said process is operated separately for each group of pictures having same values of temporal scalability and inter-layer coding dependency.

14. The electronic device according to claim 12, wherein said electronic device is one of the following: a mobile phone, a computer, a PDA device, a set-top box for a digital television system, a gaming console, a media player or a television.

15. A computer program product, stored on a computer readable medium and executable in a data processing device, for decoding a scalable video data stream comprising a base layer and at least one enhancement layer, the computer program product comprising
a computer program code section for decoding pictures of the video data stream according to a first decoding algorithm, if pictures only from the base layer are to be decoded; and
a computer program code section for decoding pictures of the video data stream according to a second decoding algorithm, if pictures from the base layer and from at least one enhancement layer are to be decoded.

16. The computer program product according to claim 15, wherein the computer program product further comprises:
a computer program code section for decoding signalling information received with a scalable data stream, said signalling information including information about temporal scalability and inter-layer coding dependencies of pictures on said layers;
a computer program code section for decoding the pictures on said layers in decoding order; and
a computer program code section for buffering the decoded pictures according to an independent sliding window process such that said process is operated separately for each group of pictures having same values of temporal scalability and inter-layer coding dependency.

17. A method of encoding a scalable video data stream comprising a base layer and at least one enhancement layer, the method comprising:
generating and encoding a reference picture list for prediction, said reference picture list enabling creation of the same picture references, if a first decoded reference picture marking algorithm is used for a data stream modified to comprise only the base layer, or if a second decoded reference picture marking algorithm is used for a data stream comprising at least part of said at least one enhancement layer.

18. The method according to claim 17, further comprising:
marking the decoded reference pictures on temporal level 0 as long-term reference pictures.

19. The method according to claim 17, further comprising:
preventing memory management control operations tackling long-term reference pictures for the decoded pictures on temporal levels greater than 0.

20. The method according to claim 17, further comprising:
restricting memory management control operations tackling short-term pictures only for the decoded pictures on the same or higher temporal level than the current picture.

21. A video encoder comprising an encoder configured for generating and encoding a reference picture list for prediction, said reference picture list enabling creation of the same picture references, if a first decoded reference picture marking algorithm is used for a data stream modified to comprise only a base layer of a scalable video data stream comprising a base layer and at least one enhancement layer, or if a second decoded reference picture marking algorithm is used for a data stream comprising at least part of said at least one enhancement layer.

22. An electronic device comprising an encoder configured for generating and encoding a reference picture list for prediction, said reference picture list enabling creation of the same picture references, if a first decoded reference picture marking algorithm is used for a data stream modified to comprise only a base layer of a scalable video data stream comprising a base layer and at least one enhancement layer, or if a second decoded reference picture marking algorithm is used for a data stream comprising at least part of said at least one enhancement layer.

23. The electronic device according to claim 22, wherein said electronic device is one of the following: a mobile phone, a computer, a PDA device, a set-top box for a digital television system, a gaming console, a media player or a television.

24. A computer program product, stored on a computer readable medium and executable in a data processing device, for encoding a scalable video data stream comprising a base layer and at least one enhancement layer, the computer program product comprising:
a computer program code section for generating and encoding a reference picture list for prediction, said reference picture list enabling creation of the same picture references, if a first decoded reference picture marking algorithm is used for a data stream modified to comprise only the base layer, or if a second decoded reference picture marking algorithm is used for a data stream comprising at least part of said at least one enhancement layer.

25. An electronic device comprising:
means for decoding pictures of the video data stream comprising a base layer and at least one enhancement layer according to a first decoding algorithm, if pictures only from the base layer are to be decoded; and
means for decoding pictures of the video data stream according to a second decoding algorithm, if pictures from the base layer and from at least one enhancement layer are to be decoded.
